(19) United States
(12) Patent Application Publication
(10) Pub. No.: US 2014/0380464 A1
(43) Pub. Date: Dec. 25, 2014

(54) ELECTRONIC DEVICE FOR DISPLAYING LOCK SCREEN AND METHOD OF CONTROLLING THE SAME

(71) Applicant: Samsung Electronics Co., Ltd., Gyeonggi-do (KR)

(72) Inventor: Sun-Gi Lee, Seoul (KR)

(73) Assignee: Samsung Electronics Co., Ltd.

(21) Appl. No.: 14/309,297

(22) Filed: Jun. 19, 2014

(30) Foreign Application Priority Data
Jun. 19, 2013 (KR) 10-2013-0070394

(51) Int. Cl. G06F 21/36; G06F 3/01

(52) U.S. Cl. CPC G06F 21/36; G06F 3/017
USPC 726/19

(57) ABSTRACT

A method of controlling an electronic device providing a lock screen is provided. The method includes providing the lock screen; detecting and analyzing an event for outputting at least one output event, which is received in the lock screen, so as to determine the output event to be output based on the analysis result; determining at least one module for providing the output event corresponding to the analysis result so as to provide an output instruction to output the output event to the at least one determined module; and outputting the output event by the at least one determined module.

### PRIORITY

This application claims priority under 35 U.S.C. §119(a) to Korean Patent Application Serial No. 10-2013-0070394, which was filed in the Korean Intellectual Property Office on Jun. 19, 2013, the entire content of which is incorporated herein by reference.

### BACKGROUND

1. Field of the Invention

The present invention generally relates to an electronic device for displaying a lock screen and a method of controlling the same, and more particularly, to an electronic device for displaying a lock screen and a method of controlling the same, which are capable of outputting various output events.

2. Description of the Related Art

Recently, smart phones and a tablet Personal Computers (PC) have became increasingly popular, and can perform data communication and voice calls as a conventional mobile communication terminal. In addition, the smart phone or the tablet PC executes various applications like a conventional personal computer, so as to meet a user's requirements.

When the smart phone or the tablet PC is not used, a display unit is controlled to be turned off in order to reduce consumption of electricity. When a user intends to use the smart phone or the tablet PC, he/she operates the smart phone or the tablet PC by pushing a certain button so that the display unit is turned on.

When the button is pushed to turn on the display unit, the smart phone or the tablet PC may display a menu screen including a launcher screen or an application list. On the other hand, in order to protect the user's privacy, the user can control the smart phone or the tablet PC so that the smart phone or the tablet PC displays a lock screen when a button is pushed to turn on the display unit. Here, the lock screen is a screen in which the menu screen including the launcher screen or the application list is displayed only when a preset pattern or password is input.

A User Interface (UI) is conventionally provided as the lock screen, which is implemented in a simple application so that a user may input a preset pattern or password.

Recently, lock screen applications have been popularized through which a user is able to display a desired image on a screen of the lock screen application. However, it is very restrictive for the user to edit the conventional lock screen application described above. Accordingly, development of a technology in which the user can utilize the lock screen in his/her desired manner has been required.

On the other hand, the reason for restricting a user's editing of the conventional lock screen is because the conventional lock screen application is mainly made by a manufacturer of the smart phone or the tablet PC and used in the smart phone or the tablet PC. It is very restrictive for the user to edit the pre-made application. As well, there is a demand for development of a lock screen capable of providing various output events compared to the conventional lock screen allowing only visually rendered data to be output. In addition, development of a middleware engine or the like which is associated with various modules in an electronic device to provide the above mentioned various output events is required.

### SUMMARY

The present invention has been made to solve at least the above-mentioned problems in the conventional art and to provide at least the advantages described below, to respond to a demand for the development of the above-mentioned technologies. Accordingly, an aspect of the present invention is to provide an electronic device for providing a lock screen and a method of controlling the same, which are capable of outputting various output events.

In accordance with an aspect of the present invention, a method of controlling an electronic device providing a lock screen is provided. The method includes providing the lock screen; detecting and analyzing an event for outputting at least one output event which is input into the lock screen, and determining an output event to be output based on the analysis result; determining at least one module for providing the output event corresponding to the analysis result, so as to provide an output instruction to output the output event to at least one determined module; and outputting the output event by the at least one determined module.

In accordance with another aspect of the present invention, an electronic device for providing a lock screen is provided. The electronic device includes a lock-ware manager which provides the lock screen, and detects an event for outputting at least one output event input in the lock screen; a lock-ware engine which analyzes the detected event, determines an output event to be output, determines at least one module which provides the output event, and transmits an output instruction to output the output event to at least one determined module; and the at least one determined module which outputs the output event.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram schematically illustrating a device according to an embodiment of the present invention;

FIG. 2 is a block diagram illustrating an electronic device for providing a lock screen according to an embodiment of the present invention, which is capable of providing various output events;

FIG. 3A is a flow diagram illustrating a process of controlling the electronic device according to the embodiment of the present invention;

FIG. 3B is a flow diagram illustrating a process of controlling an electronic device and a server according to another embodiment of the present invention;

FIG. 4A is a block diagram illustrating a detailed configuration of a lock-ware manager according to the embodiment of the present invention;

FIG. 4B is a block diagram illustrating a detailed configuration of a lock-ware engine according to the embodiment of the present invention;

FIG. 5 is a block diagram illustrating a server and structural elements related to the server;

FIG. 6 is a block diagram illustrating an authoring tool according to the embodiment of the present invention;

FIG. 7 is a flowchart illustrating a process of controlling the electronic device according to the embodiment of the present invention;

FIGS. 8A and 8B are conceptual screen views illustrating lock screens displayed on an electronic device according to various embodiments of the present invention;

FIG. 9 is a flowchart illustrating a process of controlling the electronic device according to another embodiment of the present invention;

FIGS. 10A to 10E, 11A to 11C, 12A, 12B, 13A and 13B are conceptual screen views illustrating a multimedia embedded lock screen according to the various embodiments of the present invention;

FIGS. 14A to 14C are conceptual screen views illustrating an example of an application store which sells a lock screen according to another embodiment of the present invention;

FIG. 15 is a flowchart illustrating a process of making a lock screen application according to another embodiment of the present invention;

FIGS. 16A to 16C are conceptual screen views illustrating an authoring tool devices according to the various embodiments of the present invention; and

FIG. 17A is a conceptual screen view illustrating a PC based executable authoring tool, and FIGS. 17B and 17C are conceptual screen views illustrating an authoring tool executed in a mobile device.

### DETAILED DESCRIPTION OF EMBODIMENTS OF THE PRESENT INVENTION

Hereinafter, specific embodiments of the present invention will be described with reference to the accompanying drawings. However, the present invention is not restricted or limited by the embodiments. The same reference numerals represented in each of the drawings indicate the elements that perform substantially the same functions.

According to various embodiments of the present invention, an electronic device for providing the lock screen outputting the output event in various forms and the method of controlling the same may be provided. In addition, it is possible to provide an authoring tool through which the user can develop an application program for the lock screen, a server for managing the authoring tool developed by the user, the electronic device for executing the authoring tool developed by the user, and the method of controlling the same.

Therefore, the user can develop the application program for the lock screen in his/her desired manner. By providing a middleware engine for associating the lock screen with the modules which provides various output events included in the electronic device, the development of the application program for the lock screen can be easily implemented. In particular, although the user is not practiced in using the software, it is possible to allow the user to develop the application program for the lock screen in an intuitive manner, thereby inducing a user's participation. Furthermore, a service vendor can provide an application program for the lock screen, which is associated with advertisement for informing of the service vendor when the lock screen is provided.

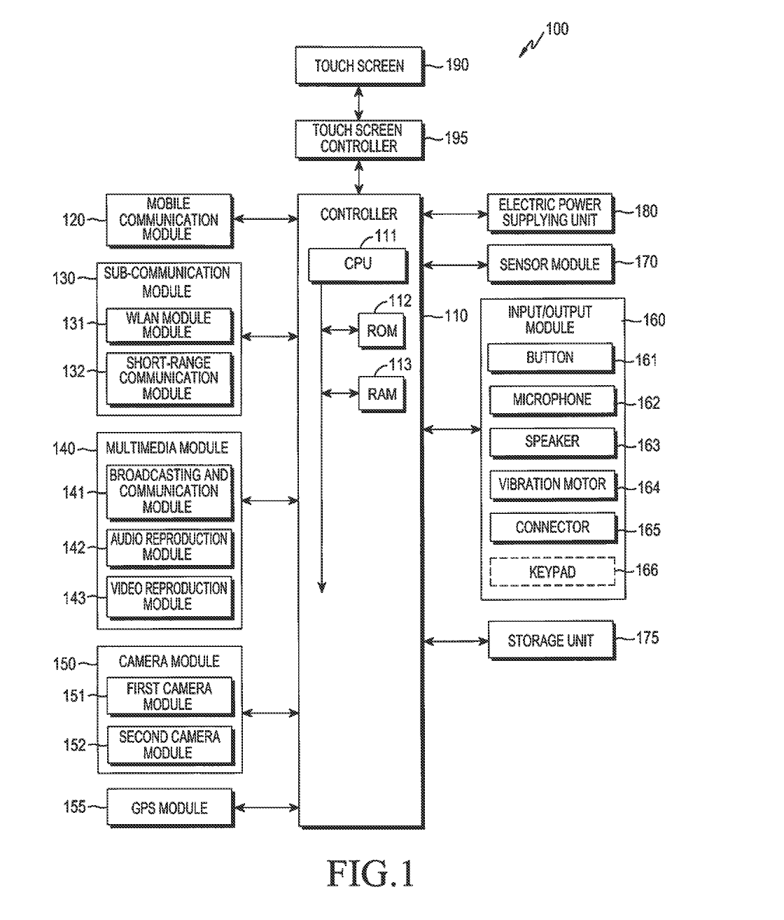

FIG. 1 is a block diagram schematically illustrating a device according to an embodiment of the present invention.

Referring to FIG. 1, an electronic device 100 may be connected to an external device by using a mobile communication module 120, a sub communication module 130, and a connector 165. The “external device” includes another device, a portable phone, a smart phone, a tablet PC, a server, a sensor, an external IT device and the like.

Referring to FIG. 1, the mobile apparatus 100 includes a touch screen 190 and a touch screen controller 195. Further, the electronic device 100 includes a controller 110, a mobile communication module 120, a sub communication module 130, a multimedia module 140, a camera module 150, a GPS module 155, an input/output module 160, a sensor module 170, a storage unit 175, and an electric power supplying unit 180. The sub communication module 130 includes at least one of a wireless LAN module 131 and a short range communication module 132, and the multimedia module 140 includes at least one of a broadcasting and communication module 141, an audio reproduction module 142, and a video reproduction module 143. The camera module 150 includes at least one of a first camera 151 and a second camera 152. The input/output module 160 includes at least one of a button 161, a microphone 162, a speaker 163, a vibration motor 164, a connector 165, and a keypad 166.

The controller 110 may include a CPU 111, a ROM 112 storing a control program for controlling the electronic device 100, and a RAM 113 used as a storage area for storing a signal or data input from the outside of the electronic device 100 or for work performed in the electronic device 100. The CPU 111 may include a single core CPU, a dual core CPU, a triple core CPU, or a quad core CPU. The CPU 111, the ROM 112 and the RAM 113 may be connected with one another through internal buses.

The controller 110 controls the mobile communication module 120, the sub-communication module 130, the multimedia module 140, the camera module 150, the GPS module 155, the input/output module 160, the sensor module 170, the storage unit 175, the electric power supplying unit 180, the touch screen 190, and the touch screen controller 195.

The mobile communication module 120 enables the electronic device 100 to be connected with an external device through mobile communication by using one or more antennas under a control of the controller 110. The mobile communication module 120 transmits/receives a wireless signal for a voice call, a video call, a Short Message Service (SMS), or a Multimedia Message Service (MMS) to/from a mobile phone, a smart phone, a tablet PC, or another device having a phone number input into the electronic device 100.

The sub-communication module 130 may include at least one of the wireless LAN module 131 and the short range communication module 132. For example, the sub-communication module 130 may include only the wireless LAN module 131, only the short range communication module 132, or both the wireless LAN module 131 and the short range communication module 132.

The wireless LAN module 131 may be connected to the Internet in a place where a wireless Access Point (AP) is installed, under the control of the control unit 110. The wireless LAN module 131 supports a wireless LAN standard (IEEE802.11x) of the Institute of Electrical and Electronics Engineers (IEEE). The short range communication module 132 may wirelessly perform short range communication between the electronic device 100 and an image forming apparatus under a control of the controller 110. A short range communication scheme may include a Bluetooth communication scheme, an Infrared Data Association (IrDA) communication scheme, a WiFi-Direct communication scheme, a Near Field Communication (NFC) scheme and the like.

The electronic device 100 may include at least one of the mobile communication module 120, the wireless LAN module 131, and the short range communication module 132 according to the performance thereof. For example, the electronic device 100 may include a combination of the mobile communication module 120, the wireless LAN module 131, and the short range communication module 132 according to a performance thereof.

The multimedia module 140 includes the broadcasting and communication module 141, the audio reproduction module 142 and the video reproduction module 143. The broadcasting and communication module 141 receives a broadcasting signal, e.g., a TV broadcasting signal, a radio broadcasting signal or a data broadcasting signal, which is transmitted from a broadcasting station and broadcasting added information, e.g., Electric Program Guide (EPG) or Electric Service Guide (ESG) through a broadcasting and communication antenna under the control of the controller 110. The audio reproduction module 142 reproduces a stored or received digital audio file, e.g., a file of which the file extension is mp3, wma, ogg, or way, under the control of the controller 110. The video reproduction module 143 reproduces a stored or received digital video file, e.g., a file of which the file extension is mpeg, mpg, mp4, avi, mov, or mkv, under the control of the controller 110. The video reproduction module 143 may reproduce a digital audio file.

The multimedia module 140 may include the audio reproduction module 142 and the video reproduction module 143 without for the broadcasting and communication module 141. Also, the audio reproduction module 142 or the video reproduction module 143 of the multimedia module 140 may be included in the controller 110.

The camera module 150 includes at least one of the first camera 151 and the second camera 152 each of which photographs a still image or a video under the control of the controller 110. In addition, the first camera 151 or the second camera 152 may include an auxiliary light source, e.g., a flash that provides an amount of light necessary for photography. The first camera 151 may be disposed in a front surface of the electronic device 100, and the second camera 152 may be disposed in a rear surface of the electronic device 100. In a different way, the first camera 151 and the second camera 152 may be disposed to be adjacent to each other, for example, an interval between the first camera 151 and the second camera 152 is larger than 1 cm and smaller than 8 cm, and thus a three-dimensional still image or a three-dimensional video may be photographed.

The GPS module 155 receives radio waves from a plurality of GPS satellites in the Earth's orbit and calculates a position of the electronic device 100 by using Time of Arrival from the GPS satellites to the electronic device 100.

The input/output module 160 includes at least one of a plurality of buttons 161, a 30 microphone 162, a speaker 163, a vibration motor 164, a connector 165, and a keypad 166.

The buttons 161 may be formed on a front surface, a side surface, or a rear surface of the housing of the electronic device 100, and may include at least one of a power/lock button, a volume control button, a menu button, a home button, a back button, and a search button 161.

The microphone 162 receives a voice or a sound to generate an electrical signal under a control of the controller 110.

The speaker 163 outputs sounds corresponding to various signals, for example, a wireless signal, a broadcasting signal, a digital audio file, a digital video file, photographing or the like, of the mobile communication module 120, the sub communication module 130, the multimedia module 140, or the camera module 150 to the outside of the apparatus 100 under a control of the controller 110. The speaker 163 outputs a sound, for example, a button operation sound corresponding to a phone call or ringing tone, corresponding to a function performed by the electronic device 100. One or more speakers 163 may be arranged on a suitable position or positions of the housing of the electronic device 100.

The vibration motor 164 converts an electric signal to mechanical vibration under the control of the control unit 110. For example, when the electronic device 100 in a vibration mode receives a voice call from another device, a vibration motor operates. One or more vibration motors 164 may be arranged within the housing of the electronic device 100. The vibration motor 164 may operate in response to a touch operation of a user who touches the touch screen 190 and a continuous touch movement on the touch screen 190.

The connector 165 is used as an interface which connects the electronic device 100 with an external device or an electric power source. The electronic device 100 may transmit data stored in the storage unit 175 of the electronic device 100 to the external device or receive data from an external device through a wired cable connected to the connector 165 under the control of the controller 110. The electronic device 100 may be supplied with electric power from the electric power source or charge a battery thereof, through the wired cable connected to the connector 165.

The keypad 166 receives a key input from the user for the control of the electronic device 100. The keypad 166 includes a physical keypad formed on the electronic device 100 or a virtual keypad displayed on the touch screen 190. The physical keypad mounted on the electronic device 100 may be excluded according to the performance or the structure of the electronic device 100.

The sensor module 170 includes at least one sensor for detecting a status of the electronic device 100. For example, the sensor module 170 may include a proximity sensor for detecting whether the user is close to the electronic device 100, an illumination sensor for detecting an amount of light around the electronic device 100, or a motion sensor for detecting a movement of the electronic device 100, for example, a rotation of the electronic device 100, or an acceleration or vibration applied to the electronic device 100. At least one sensor may detect the status of the electronic device and generate a signal corresponding to the detection so as to transmit the signal to the controller 110. The sensors of the sensor module 170 may be added or omitted according to the performance of the electronic device 100.

The storage unit 175 stores signals or data input/output in response to the operations of the mobile communication module 120, the sub-communication module 130, the multimedia module 140, the camera module 150, the GPS module 155, the input/output module 160, the sensor module 170, and the touch screen 190 under a control of the controller 110. The storage unit 175 stores a control program and applications for controlling the electronic device 100 or the controller 110.

The term “storage unit” includes the storage unit 175, the ROM 112 and the RAM 113 within the controller 110, or a memory card, for example, an SD card or a memory-stick, installed in the electronic device 100. The storage unit may include a non-volatile memory, a volatile memory, a Hard Disc Drive (HDD) or a Solid State Drive (SSD).

The electric power supplying unit 180 supplies electric power to one or more batteries disposed in the housing of the electronic device 100 under a control of the controller 110. The one or more batteries supply electric power to the electronic device 100. Further, the electric power supplying unit 180 supplies the electronic device 100 with electric power input from an external electric power source through the wired cable connected to the connector 165.

The touch screen 190 provides a user with a User Interface (UI) corresponding to various services, for example, a voice call, data transmission, broadcasting, and photographing. The touch screen 190 transmits an analog signal corresponding to at least one touch input into the user interface to the touch screen controller 195. The touch screen 190 receives an input of at least one touch through a body of the user, e.g., fingers, or a touchable input means, e.g., a stylus pen. Also, the touch screen 190 may receive a continuous motion of one touch among one or more touches. The touch screen 190 transmits an analog signal corresponding to the continuous movement of the touch input thereto to the touch screen controller 195.

In the present invention, the touch is not limited to a contact of the touch screen 190 with the user's body or the touchable input means, but also includes a noncontact hover in which a distance between the touch screen 190 and the user's body or the touchable input means is less than or equal to 1 mm. The distance of the noncontact hover detected by the touch screen 190 may be changed according to the performance or the structure of the electronic device 100.

The touch screen 190 may be implemented in, for example, a resistive type, a capacitive type, an infrared type, or an acoustic wave type.

The touch screen controller 195 converts the analog signal received from the touch screen 190 to a digital signal, e.g., X and Y coordinates, and transmits the digital signal to the controller 110. The controller 110 controls the touch screen 190 by using the digital signal received from the touch screen controller 195. For example, the controller 110 may allow a shortcut icon, which is displayed on the touch screen 190, to be selected, or may execute the shortcut icon in response to a touch. Further, the touch screen controller 195 may be included in the controller 110.

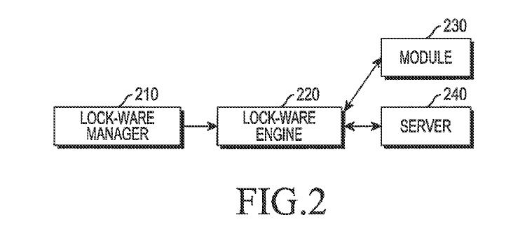

FIG. 2 is a block diagram illustrating an electronic device for providing a lock screen according to an embodiment of the present invention, which is capable of providing various output events.

As shown in FIG. 2, the electronic device includes a lock-ware manager 210, a lock-ware engine 220, and a module 230, and the lock-ware engine 220 transmits and receives a signal to/from a server 240.

The lock-ware manager 210 is a device manager which operates the lock-ware for driving the lock screen, and may include a content platform interface.

Here, the lock-ware manager 210 manages execution or finishing of an application, manages used or idling resources, manages packages, collects location information, outputs notifications, and the like. The lock-ware manager 210 may be defined, for example, by a framework of an Operating System (OS). The lock-ware manager 210 may be independently defined regardless of the framework of the existing OS, or may be defined by correcting the existing OS.

The lock-ware manager 210 detects events. Here, the event may be a user input on the touch screen 190, a GPS coordinate of a location at which the electronic device 100 is located, an address of a Wi-Fi station which the electronic device 100 accesses based on a Wi-Fi scheme, an address of an Access Point (AP) which the electronic device 100 accesses based on a wireless data communication scheme, and the like. The lock-ware manages 210 outputs the detected event to the lock-ware engine 220.

The lock-ware engine 220 analyzes the input event, and decides a module to which the analyzed event is provided. For example, the lock-ware engine 220 may be implemented as a middleware which receives the input event and enables a hardware module to operate. The lock-ware engine 220 enables the touch screen 190 to display rendered data of the lock screen, or enables the speaker 163 to output a voice.

The lock-ware engine 220 includes at least one algorithm preset in the lock-ware. Here, the at least one algorithm preset in the lock-ware may be authored by a manufacturer, or authored or edited by a user. The algorithm will be described in detail below. The lock-ware engine 220 regards the input event as an input factor, and applies the input event to the at least one algorithm preset in the lock-ware. The lock-ware engine 220 decides an output event based on a result from the application of the algorithm. In addition, the lock-ware engine 220 can decide a module 230 to which the output event is provided. The lock-ware engine 220 may include a runtime for driving the lock-ware, an Application Processor Interface (API) used to make the lock-ware, an UI for a mobile lock-ware, and the like.

According to an embodiment described in detail below, for example, the lock-ware manager 210 collects a GPS coordinate input from the GPS module 155, and outputs the collected GPS coordinate to the lock-ware engine 220. The lock-ware engine 220 applies the GPS coordinate as an input factor to the preset algorithm. The lock-ware engine 220 may store, for example, an algorithm for outputting a photograph corresponding to the GPS coordinate. The lock-ware engine 220 determines a corresponding photograph, image, data, or the like as the output event based on the input GPS coordinate of the electronic device 100. In addition, the lock-ware engine 220 determines the touch screen 190 as a module to which the output event is provided. The lock-ware engine 220 provides an output instruction to the module, i.e., the touch screen 190, to which the output event is provided, and the touch screen 190 outputs the output event.

The module 230 refers to hardware capable of outputting the output event. The module 230 receives the output instruction from the lock-ware engine 220, and outputs the output event in response to the output instruction. The module 230 may be implemented in various forms such as a speaker 163, a vibration motor 164 and the like, and it will be understood by those skilled in the art that the module 230 includes any hardware if it can output the output event.

The server 240 transmits and receives data to/from the lock-ware engine 220. In the above mentioned embodiment, for example, the lock-ware engine 220 transmits information on the GPS coordinate to the server 240, and the server 240 analyzes the received information on the GPS coordinate of the electronic device 100. The server 240 may determine a photograph, an image, data or the like corresponding to the GPS coordinate by using the preset algorithm, and transmit the determined photograph and the like to the lock-ware engine 220. The lock-ware engine 220 outputs the received photograph and the like to the module 230, and controls the module 230 to display the received photograph and the like.

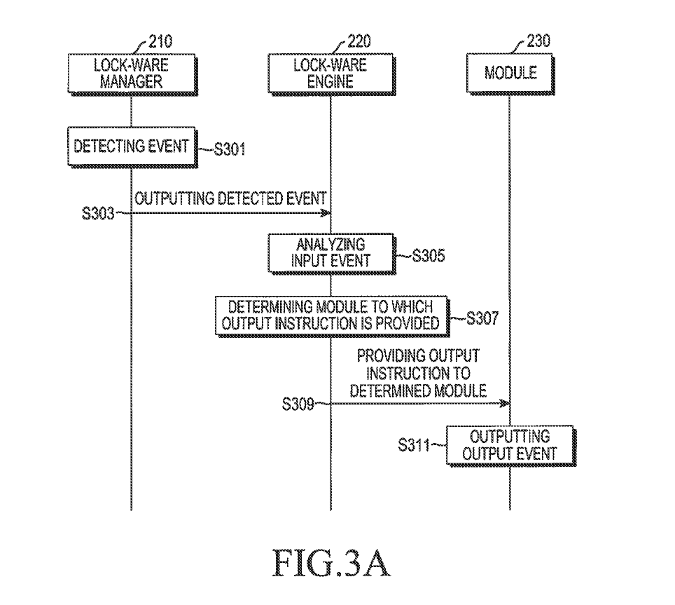

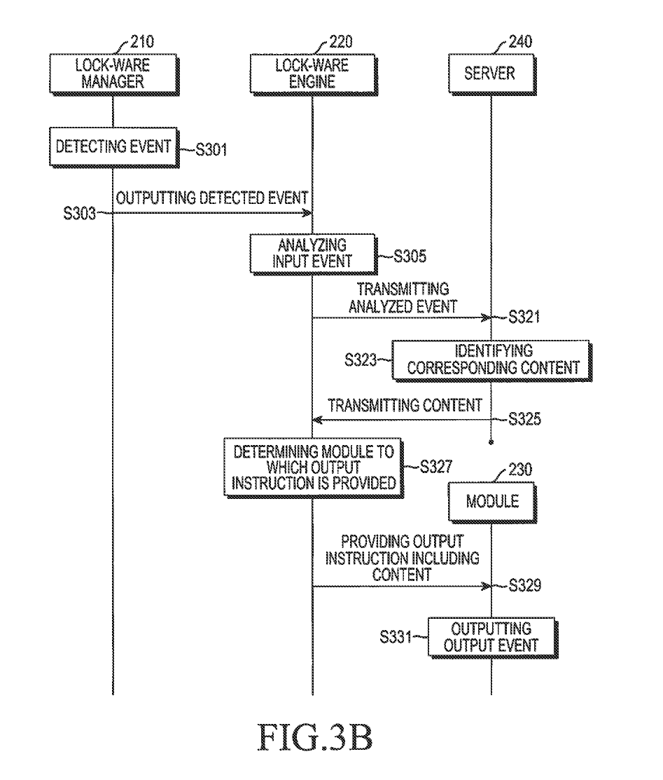

FIG. 3A is a flow diagram illustrating a process of controlling the electronic device according to the embodiment of the present invention.

The lock-ware manager 210 detects an event in step S301, and outputs the detected event to the lock-ware engine 220 in step S303. The lock-ware engine 220 analyzes the input event in step S305, and decides a module to which the analyzed event is provided in step S307. The determination of the module to which the output event is provided may be performed based on the preset lock-ware algorithm.

The lock-ware engine 220 provides the output event to the determined module in step S309, and the module 230 outputs the output event in step S311.

FIG. 3B is a flow diagram illustrating a process of controlling an electronic device and a server according to another embodiment of the present invention.

The detailed description of steps S301, S303 and S305 will be omitted because they are described above. The lock-ware engine 220 transmits the analyzed event to the server 240 in step S321. For example, the lock-ware engine 220 transmits the collected GPS coordinate of the electronic device 100 to the server 240 in step S321.

The server 240 identifies contents corresponding to the received event in step S323. For example, the server 240 may determine a photograph, an image, data or the like corresponding to the GPS coordinate of the electronic device 100. The server 240 transmits and receives data to/from the lock-ware engine 220. For example, the server 240 transmits the determined photograph to the electronic device 100 in step S325. The lock-ware engine 220 determines a module to which the output event is provided in step S327, and provides an output instruction including content to the module 230 in step S329. The module 230 outputs the output event and displays the photograph or the like received from the server 240 in step S331.

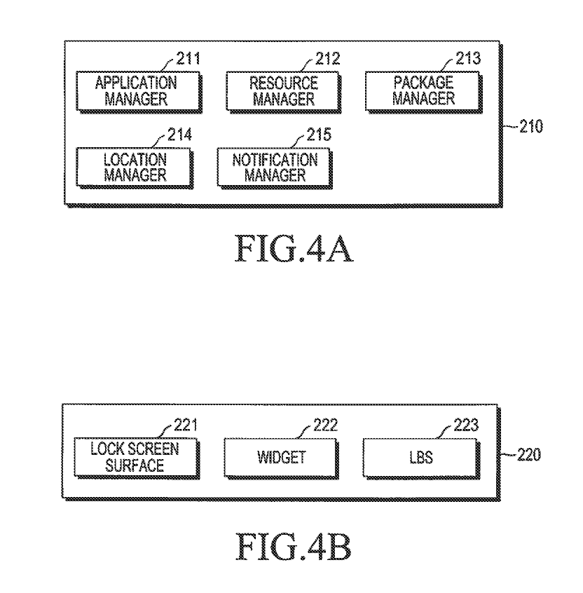

FIG. 4A is a block diagram illustrating a detailed configuration of a lock-ware manager according to the embodiment of the present invention.

An application manager 211 performs a function of managing a process and a function necessary for executing an application program on the lock-ware.

A resource manager 212 performs a function of accessing and managing an uncoded resource such as characters, a graphic file, a layout file and the like.

A package manager 213 performs a function of managing a package including a class, a resource and the like so that an executable file and a process effectively share the package.

A location manager 214 performs a function of identifying information on a position of a user so as to manage the information for a Location Based Service (LBS).

A notification manager 215 performs a function of transmitting a notification message of the application to the user without interference or notifying the user of a specific event.

FIG. 4B is a block diagram illustrating a detailed configuration of a lock-ware engine according to the embodiment of the present invention.

A lock screen surface 221 performs a function of driving a library joining surfaces, each of which may be one screen, on the lock screen to each other, and an engine function of driving the library, and for example, the engine function in which various program screens are joined and various graphic effects such as a transparent window, a brilliant conversion, and the like are provided.

A widget 222 performs functions such as weather, calendar, a calculator, and the like and an engine function of supporting direct use of news, a game, information, advertisement, and the like without use of a web browser in the electronic device 100, such as a PC, a portable phone, a TV, and the like.

An LBS 223 performs an engine function of associating various additional services based on a user location with the lock-ware application through communication with the external device, e.g., server, by using the location information received from the lock-ware manager.

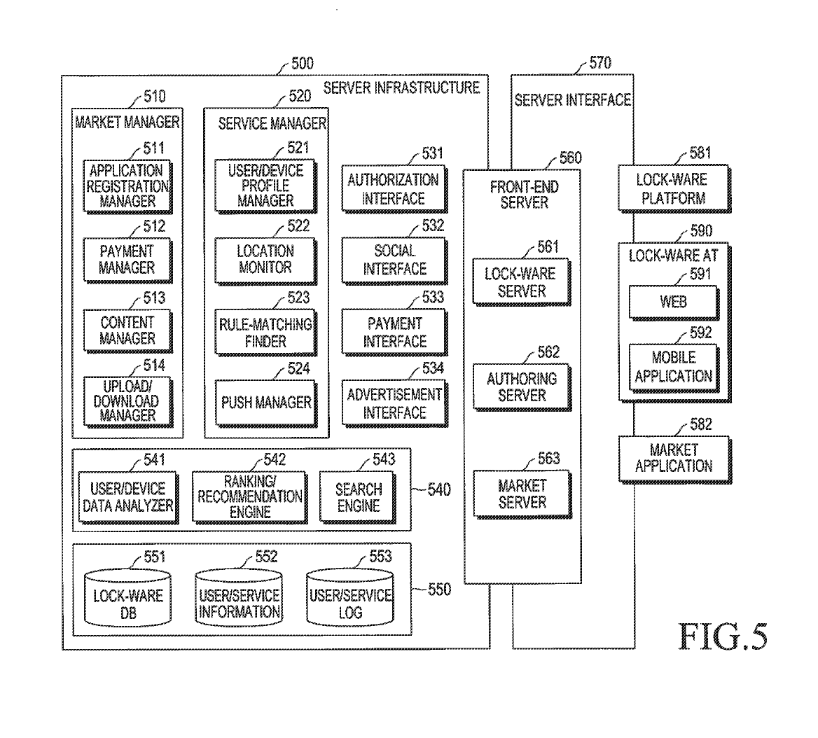

FIG. 5 is a block diagram illustrating a server and structural elements related to the server.

A server infrastructure 500 includes a market manager 510, a service manager 520, an authorization interface 531, a social interface 532, a payment interface 533, an advertising interface 534, an analysis unit 540 and a storage unit 550.

The market manager 510 includes an application registration manager 511, a payment manager 512, a content manager 513 and an uploading/downloading manager 514.

The application registration manager 511 performs a function of managing a series of processes of registering lock-ware applications made by general users or service vendors in a market server by using the authoring tool provided by the present invention.

The payment manager 512 performs a function of managing a series of processes of paying a price calculated according to a prescribed procedure when the lock-ware application made by the general user or the service vendors is sold and bought.

The content manager 513 performs a function of managing the registered lock-ware application and various service contents associated therewith.

The uploading/downloading manager 514 performs a function of managing an uploading/downloading of the lock-ware application registered in the market server and managing information on statistics of use between users.

The service manager 520 includes a user/device profile manager 521, a location monitor 522, a rule match finder 523 and a push manager 524.

In order to provide a service corresponding to a user, the user/device profile manager 521 performs a function of managing information and histories of the user and a user's own electronic device related to the corresponding service in the server.

The location monitor 522 performs a function of managing information and histories of locations obtained through various mobile communication schemes of the corresponding electronic device which the user uses, and collecting and transferring histories of movement paths to another management block in order to provide a service which must be changed according to the movement of the user.

The rule match finder 523 performs a function of checking and managing whether a specific service corresponding to the lock-ware application made by the general user or the service vendor is appropriately provided according to a corresponding rule by using the authoring tool provided by the present invention.

The push manager 524 performs a function of managing that the specific service corresponding to the lock-ware application is provided according to the corresponding rule.

The authorization interface 531 performs a protocol and interface function of mutually transferring information for the authorization of the user between a front-end server and a server infrastructure.

The social interface 532 performs a protocol and interface function of mutually transferring information necessary for a lock-ware portal through an uploading/downloading and recommendation of the application by users between the front-end server and the server infrastructure.

The payment interface 533 performs a protocol and interface function of mutually transferring information necessary for a series of processes of paying a sum of money calculated according to the prescribed procedure between the front-end server and the server infrastructure when the lock-ware application made by the general user or the service vendor is sold and bought.

The advertisement interface 534 performs a protocol and interface function of mutually transferring information on all advertisements related to a specific service between the front-end server and the server infrastructure.

The analysis unit 540 includes a user/device data analyzer 541, a ranking/recommendation engine 542 and a search engine 543.

The user/device data analyzer 541 performs a function of analyzing all data related to a corresponding service which a user and a user's own electronic device use in the server, and managing histories on data, when a service corresponding to the user is provided.

The ranking/recommendation engine 542 performs an engine function of analyzing information on a ranking through the uploading/downloading and the recommendation of the application between the users in the lock-ware portal, analyzing and managing necessary information to transfer the recommendation application of the user to another user, and operating the information.

The search engine 543 performs an engine function of searching for and analyzing various services provided to the users and their own electronic devices.

The storage unit 550 includes a lock-ware database 551, user/service information 552, and a user/service log 553.

The lock-ware database 551 performs a storage function of making and storing information on the lock-ware which the users use in the database.

The user/service information 552 performs a storage function of storing information in order to analyze service information which the user and the electronic device use.

The user/service log 553 performs a storage function of storing information in order to analyze service information which the user and the electronic device use.

The front-end server 560 includes a lock-ware server 561, an authoring server 562, and a market server 563.

The lock-ware server 561 performs a server function of providing a service corresponding to each of various lock-ware applications.

The authoring server 562 performs a server function of managing a series of all processes of allowing the general user or the service vendor to author the lock-ware application by using the authoring tools provided by the present invention.

The market server 563 performs a server function of managing a series of all processes of operating the lock-ware application authored by the general user or the service vendor in a portal site.

The lock-ware platform 581 performs an interface function of connecting the service in the lock-ware platform prescribed between the server and the electronic device.

A lock-ware AT (Authoring Tool) 590 performs a function as an authoring tool based on the lock-ware platform allowing the general user or the service vendor to author an application and as an interface between the server and the electronic device.

A web 591 is an authoring tool based on a lock-ware platform, and refers to a web based authoring tool.

A mobile application 592 is an authoring tool based on a lock-ware platform, and refers to an authoring tool capable of performing editing or manufacturing in the mobile device.

A market application 582 refers to an application developed through a lock-ware platform based authoring tool which is in common use in a market.

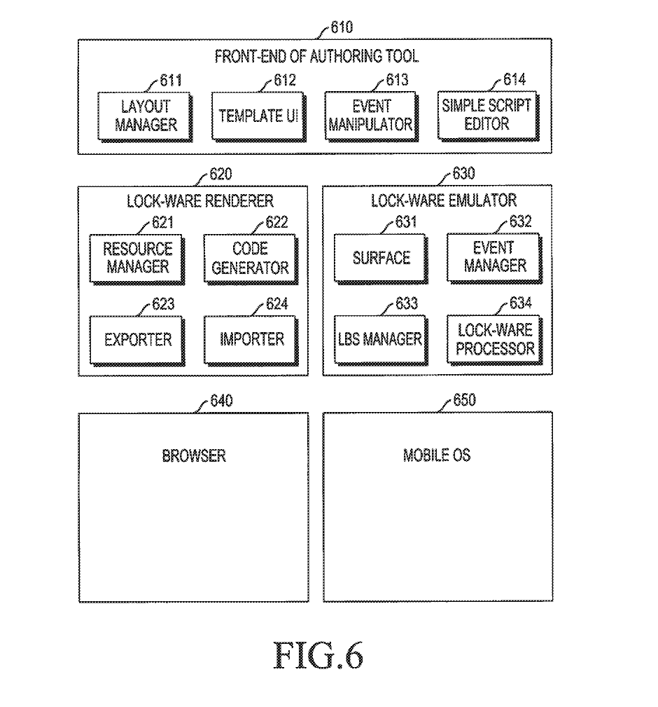

FIG. 6 is a block diagram illustrating an authoring tool according to the embodiment of the present invention.

A front-end 610 of the authoring tool includes a layout manager 611, a template UI 612, an event manipulator 613 and a simple script editor 614.

The layout manager 611 performs a function of prescribing and managing an entire appearance and layout of a selected or designated screen when the user constitutes the screen to be displayed on the display unit of the electronic device using the authoring tool.

The template UI 612 performs a function as a UI of a selected or designated template when the user constitutes the screen to be displayed on the display unit of the electronic device using the authoring tool.

The event manipulator 613 performs a function of adjusting specific event information or a value selected or designated when the user constitutes the screen to be displayed on the display unit of the electronic device by using the authoring tool.

The simple script editor 614 performs a function of writing a script in order to add and implement a function to be suitable for a user's purpose as well as a selection or designation of a given function when the user constitutes the screen to be displayed of the electronic device by using the authoring tool.

A lock-ware renderer 620 includes a resource manager 621, a code generator 622, an exporter 623, and an importer 624.

The resource manager 621 performs a function of managing a resource of necessary functions when the user manufactures an application so that it is displayed on the display unit of the electronic device.

The code generator 622 performs a function of generating authored content in the form of codes, or writing a script in order to add and implement a function to be suitable for a user's purpose as well as a selection or a designation of a given function so that the script is converted into codes, when the user manufactures an application to be displayed on the display unit of the electronic device by using the authoring tool.

The exporter 623 performs a function of transferring necessary information to the front-end of the authoring tool, when the user manufactures the application by using the authoring tool.

The importer 624 performs a function of receiving the necessary information from the front-end of the authoring tool, when the user manufactures the application by using the authoring tool.

A lock-ware emulator 630 includes a surface 631, an event manager 632, an LBS manager 633 and a lock-ware processor 634.

The surface 631 performs a function of previously identifying a state in which various and interesting graphic effects such as a semitransparent window and a brilliant conversion by joining various program screens are provided, each of which may be for example one screen, when the user manufactures a lock-ware application so that the surface performs a function as a library playing a role of joining the surfaces on the lock screen and a driving function.

The event manager 632 performs a function of previously identifying applied various event effects through the authoring tool when the user manufactures a lock-ware application by using the authoring tool.

The LBS manager 633 performs a function of previously identifying an applied LBS application function through the authoring tool when the user manufactures a lock-ware application by using the authoring tool.

The lock-ware processor 634 performs a processing function of identifying the applied functions through the authoring tool when the user manufactures the lock-ware application by using the authoring tool.

The browser 640 refers to a predetermined browser which is provided so that the user uses the lock-ware authoring tool.

A mobile OS 650 refers to a predetermined mobile OS which is provided so that the user uses the lock-ware authoring tool.

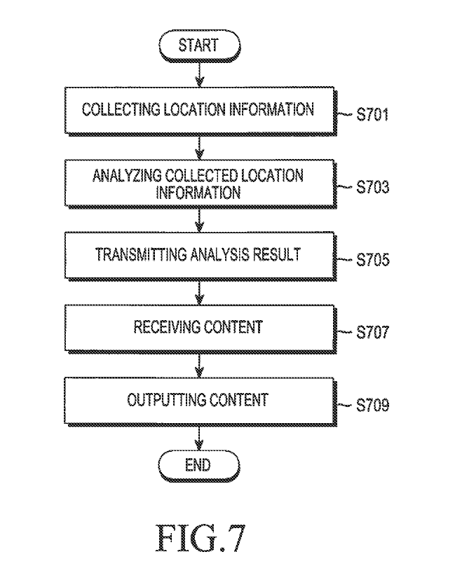

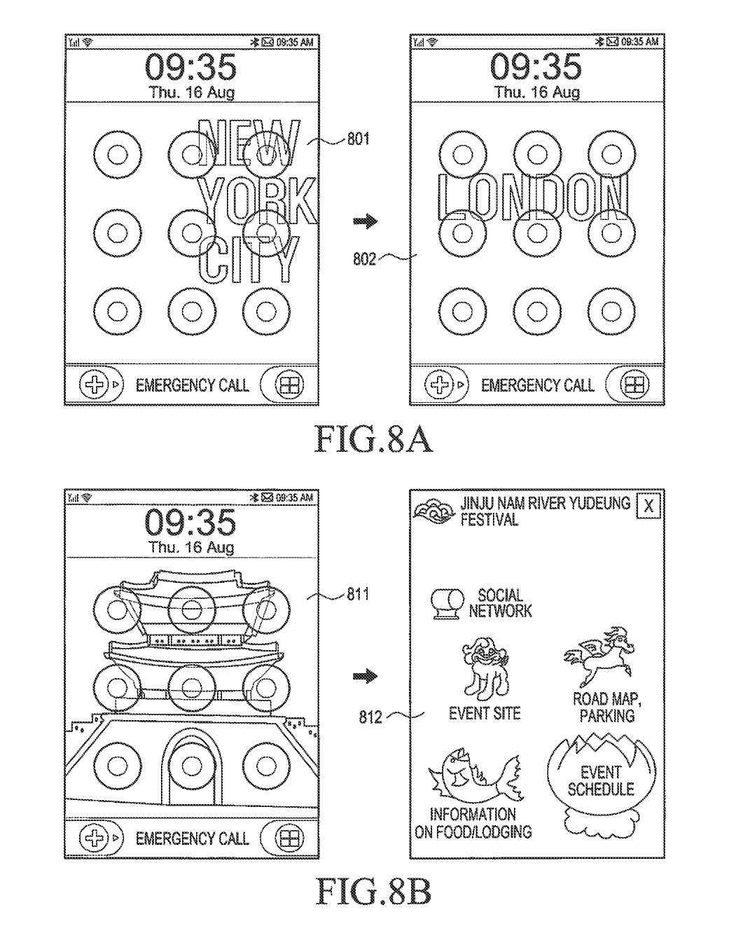

FIG. 7 is a flowchart illustrating a process of controlling the electronic device according to the embodiment of the present invention. The embodiment of FIG. 7 will be described in detail with reference to FIGS. 8A and 8B, and FIGS. 8A and 8B are conceptual screen views illustrating the lock screen displayed in the electronic device according to the various embodiments of the present invention.

The electronic device 100 collects the location information in step S701. For example, the electronic device 100 may collect at least one of AP addresses to which it is connected based on the GPS coordinates, the Wi-Fi station address and the wireless data communication scheme. The electronic device 100 analyzes the collected location information in step S703. For example, the electronic device 100 may determine a nation, a region and the like in which the electronic device 100 is located, based on at least one of the GPS coordinates, the Wi-Fi station address and the AP address. Alternately, the electronic device 100 may simply identify at least one of the GPS coordinates, the Wi-Fi station address and the AP address.

The electronic device 100 transmits the analysis result to the server 240 in step S705. In the case where the analysis result is the nation, the region and the like in which the electronic device 100 is located, the server 240 transmits contents corresponding to the nation and the region in which the electronic device 100 is located, to the electronic device 100 in step S707. That is, the electronic device 100 receives the contents corresponding to the nation and region in which the electronic device 100 is located.

On the other hand, in the case where the analysis result simply is at least one of the GPS coordinates, the Wi-Fi station address and the AP address, the server 240 determines the nation or the region in which the electronic device 100 is located, based on at least one of the received GPS coordinates, the Wi-Fi station address and the AP address. Further, the server 240 transmits the contents corresponding to the nation and the region in which the electronic device 100 is located, to the electronic device 100.

The electronic device 100 outputs the received contents in step S709.

For example, in the embodiment of FIG. 8A, when it is determined that the electronic device 100 is located in New York, the lock screen 801 is shown, and when it is determined that the electronic device 100 is located in London, the lock screen 802 is shown. On the left of FIG. 8A, the electronic device 100 may determine that the electronic device 100 is located in New York, based on at least one of the GPS coordinates, the Wi-Fi station address and the AP address. Meanwhile, the server 240 which receives at least one of the GPS coordinates, the Wi-Fi station address and the AP address collected from the electronic device 100 may determine that the electronic device 100 is located in New York. The server 240 transmits a photograph, an image, data, or the like corresponding to New York to the electronic device 100, and the electronic device 100 displays the lock screen 801 including the photograph, the image, the data, or the like corresponding to New York. On the other hand, in the case where it is determined that the electronic device 100 is located in London, the server 240 transmits a photograph, an image, data, or the like corresponding to London to the electronic device 100. The electronic device 100 displays the lock screen 802 including the photograph, the image, the data, or the like corresponding to London. As described above, the electronic device 100 displays the lock screens 801 and 802 including the photograph, the image, the data or the like corresponding to the region in which the electronic device 100 is located, and when the user moves with the electronic device 100, different lock screens may be displayed according to the location of the moved electronic device 100.

On the other hand, FIG. 8B is a conceptual screen view illustrating the lock screen according to the present invention. In FIG. 8A, a case where the content included in the lock screen is the photograph corresponding to the region in which the electronic device 100 is located has been shown. In FIG. 8B, a case where multimedia information related to the region in which the electronic device 100 is located when the lock screen is released will be described. The multimedia information related to the region in which the electronic device 10 is located may be audio-visual data downloaded from the server 240, or a web browser screen which accesses a URL corresponding to the region in which the electronic device 100 is located.

For example, in the embodiment of FIG. 8B, a case in which it is determined that the electronic device 100 is located at “Nam River in Jinju” will be described as an example. The electronic device 100 displays the multimedia information 812 related to the region in which the electronic device 100 is located, when an instruction to release the lock screen is input while the lock screen 811 is displayed. The electronic device 100 downloads and displays the audio-visual data related to the “Nam River in Jinju” from the server 240. Alternatively, the electronic device 100 may display the web browser screen which accesses the URL corresponding to the “Nam River in Jinju”.

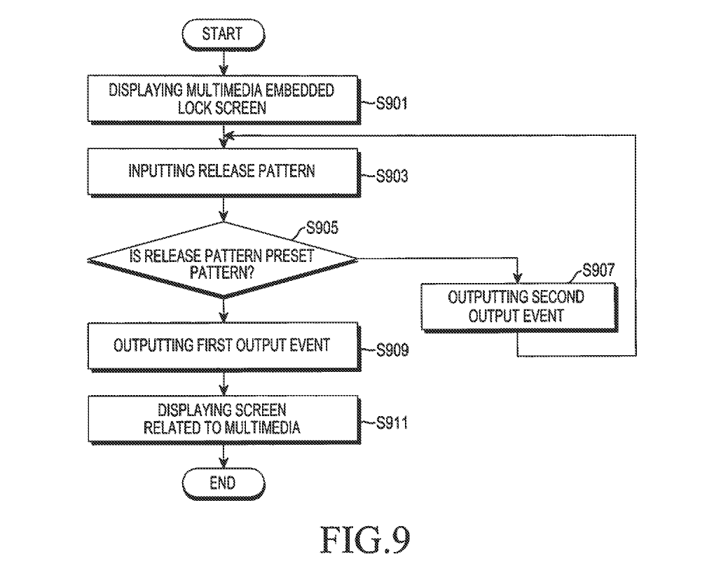

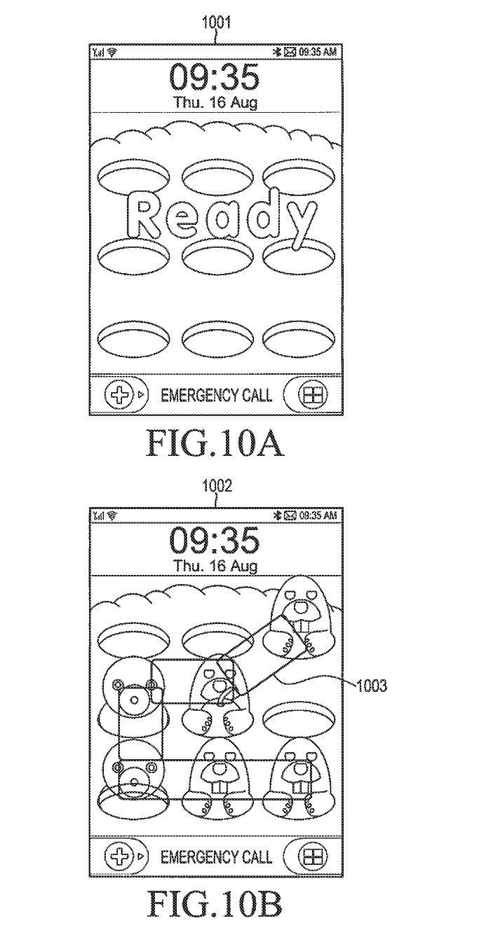

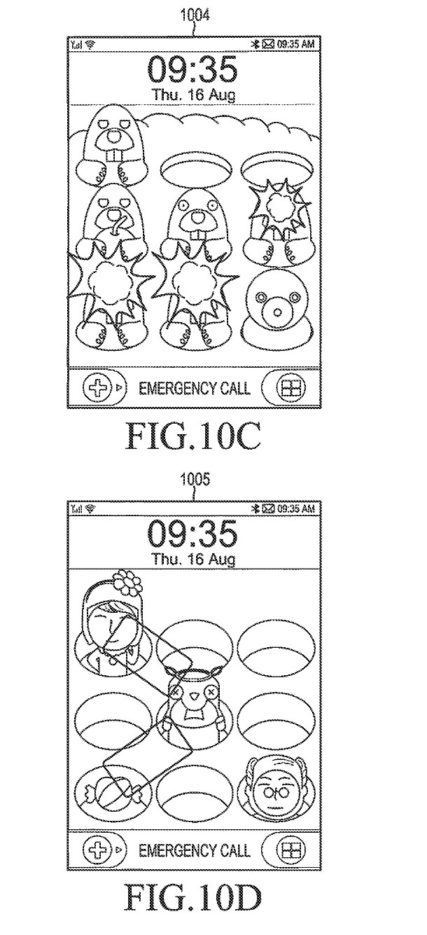

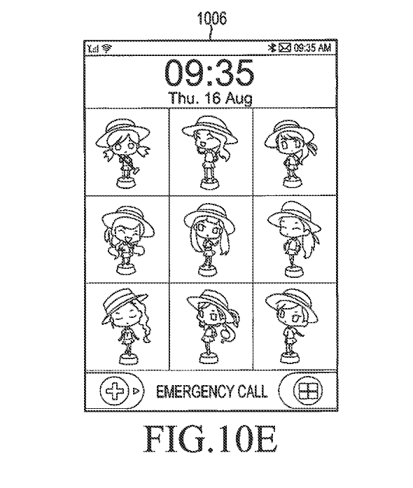

FIG. 9 is a flowchart illustrating a process of controlling the electronic device according to another embodiment of the present invention. The controlling process of FIG. 9 will be described in detail with reference to FIGS. 10A to 10E, FIGS. 11A to 11C, FIGS. 12A and 12B, and FIGS. 13A and 13B. FIGS. 10A to 10E, 11A to 11C, 12A, 12B, 13A and 13B are conceptual screen views illustrating a multimedia embedded lock screen according to the various embodiments of the present invention.

The electronic device 100 displays the multimedia embedded lock screen in step S901. Here, the multimedia embedded lock screen may be a lock screen joined to multimedia content including at least one of an image, a video, a voice, a sound, a vibration and an animation effect.

For example, the electronic device 100 may display a game screen 1001 capable of outputting an animation effect as well as a voice or a sound as the lock screen, as shown in FIG. 10A.

Referring again to FIG. 9, the electronic device 100 receives an input of a release pattern in step S903. In step S905, the electronic device determines if the release pattern is a predetermined pattern. When the release pattern is a predetermined patter in step S905, the electronic device 100 outputs a first output event in step S909, and outputs a second output event in step S907 when the release pattern is not a predetermined pattern in step S905. That is, the electronic device 100 may output different output events according to whether the release pattern is accurately input. After outputting the second output event in step S907, the electronic device returns to step S903. Further, in the case where the release pattern is accurately input and the first output event is output in step S909, the electronic device 100 displays a screen related to the multimedia in step S911.

FIG. 10B shows an example of the lock screen 1002 in the case where the release pattern according to the embodiment of the present invention is inaccurately input. In the case where the release pattern 1003 is different from the predetermined pattern as shown in FIG. 10B, the electronic device 100 may output the animation effect in which predetermined characters are displayed next to the input release pattern 1003.

FIG. 10C shows an example of the lock screen 1004 in the case where the release pattern according to the embodiment of the present invention is accurately input. As shown in FIG. 10C, when the release pattern is accurately input, the electronic device 100 outputs an animation effect in which the predetermined characters are displayed and exploded next to the input release pattern.

FIG. 10D shows an example of the lock screen according to another embodiment of the present invention. In particular, FIG. 10D shows the lock screen 1005 made by the user, and for example, the lock screen may be made by using the authoring tool described with reference to FIG. 6. The user may edit and apply the photograph, the image or the like stored in the electronic device 100 to the lock screen 1005, thereby making the lock screen 1005. The electronic device 100 may display the lock screen 1005 as shown in FIG. 10D, when it is set that the lock screen 1005 made by the user is used.

FIG. 10E shows an example of the lock screen according to another embodiment of the present invention. In particular, FIG. 10E shows the lock screen 1006 made by a service vendor, and for example, the lock screen may be made by using the authoring tool described with reference to FIG. 6.

The service vendor makes and distributes the lock screen 1006 to which an advertisement can be applied, and the electronic device 100 receives and displays the distributed lock screen 1006.

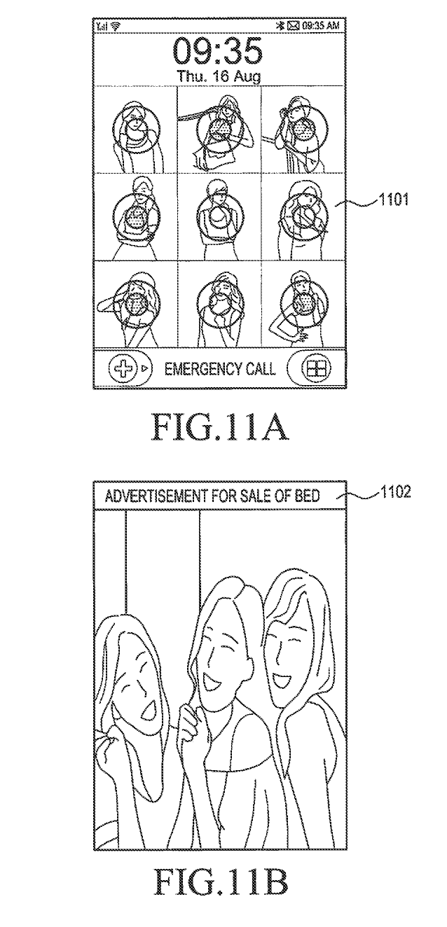

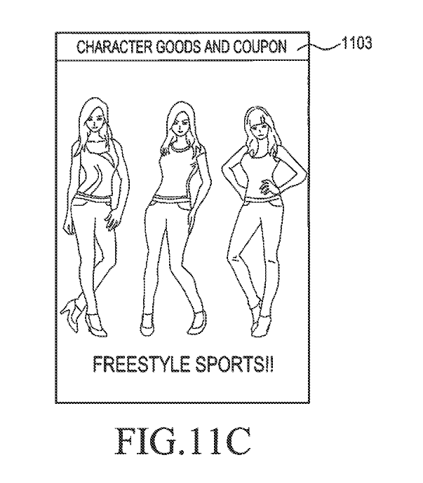

FIGS. 11A to 11C are conceptual screen views illustrating the lock screen according to another embodiment of the present invention, and a screen when the lock screen is released. As shown in FIG. 11A, it is assumed that the lock screen 1101 is made by the service vendor of FIG. 10E. When the lock screen 1101 is released, the electronic device 100 may display a web browser screen 1103 in which advertising data 1102 or a URL for selling character products is input, as shown in FIGS. 11B or 11C.

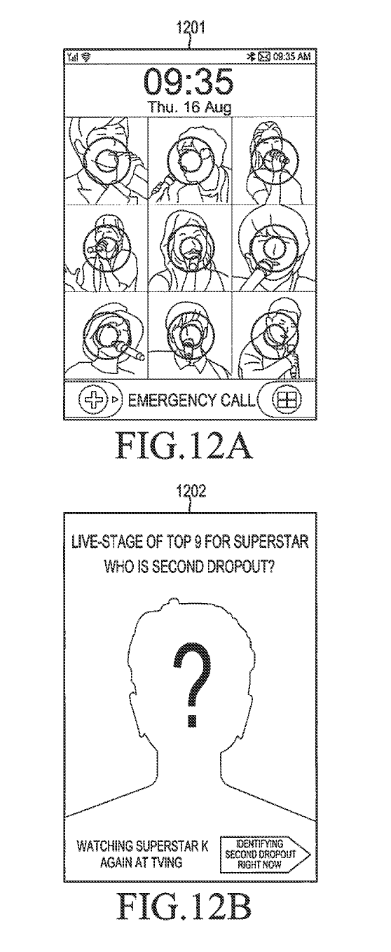

FIGS. 12A to 12B are conceptual screen views illustrating the lock screen according to another embodiment of the present invention, and a screen when the lock screen is released. As shown in FIG. 12A, it is assumed that the lock screen 1201 is made by the service vendor of FIG. 10E. For example, the service vendor of FIG. 12A may be a broadcasting station, and the broadcasting station may distribute a lock screen 1201 advertising its program. The electronic device 100 receives and displays the distributed lock screen 1201. On the other hand, when the lock screen 1201 is released, the electronic device 100 may display a web browser 1202 in which a URL corresponding to a program is input as shown in FIG. 12B.

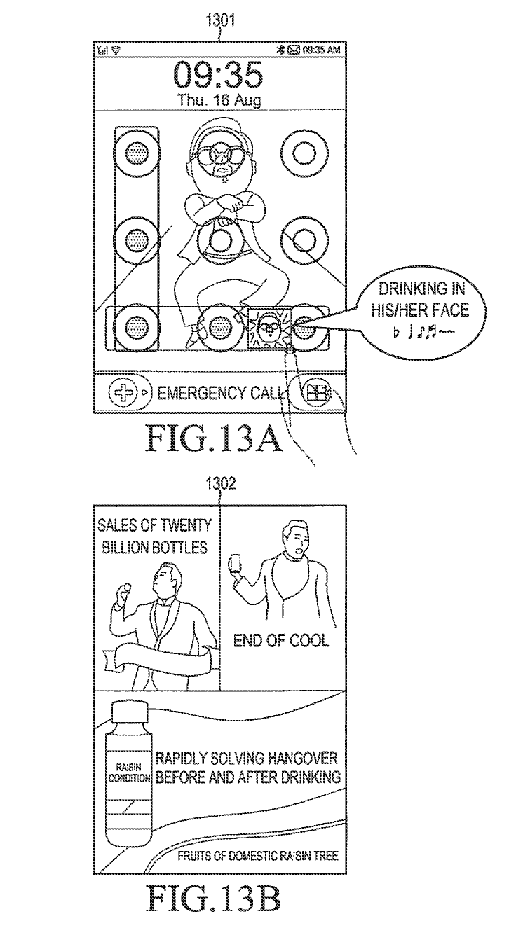

FIGS. 13A to 13B are conceptual screen views illustrating the lock screen according to another embodiment of the present invention, and a screen when the lock screen is released. As shown in FIG. 13A, it is assumed that the lock screen 1301 is made by the service vendor of FIG. 10E. For example, the service vendor of FIG. 13A may be a product seller, and the product seller may distribute a lock screen 1301 advertising its products. The electronic device 100 receives and displays the distributed lock screen 1301. In the lock screen 1301 of FIG. 13A, the image, the photograph, the animation and the like corresponding to the pattern drawn by the user move along the pattern, and when the release pattern is accurately input, a voice or a sound may be output. On the other hand, when the lock screen 1301 is released, the electronic device 100 may display a web browser 1302 in which a URL corresponding to a corresponding product is input as shown in FIG. 13B.

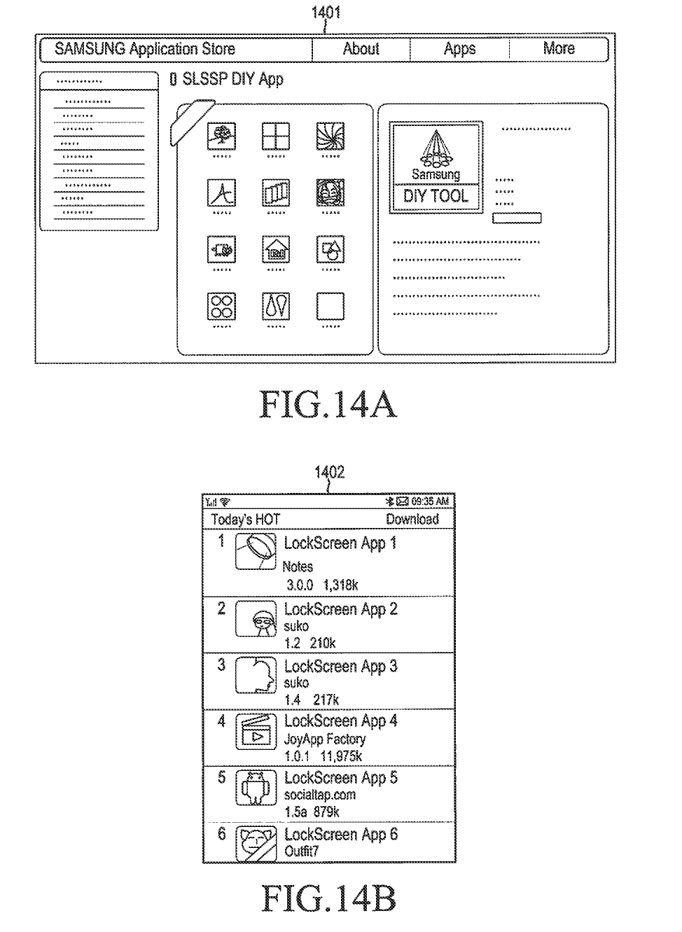

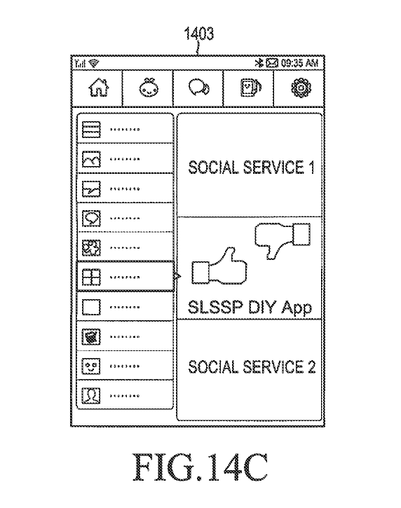

FIGS. 14A to 14C are conceptual screen views illustrating an example of an application store which sells a lock screen according to another embodiment of the present invention. In FIG. 14, the lock screen applications made by the user can be registered, and the registered lock screen applications are shown on screen 1401. In FIG. 14B, a chart in which a ranking for the sold lock screen applications is displayed on screen 1402. In addition, in FIG. 14C, a preference of the individual lock screen among different mobile applications is shown on screen 1403.

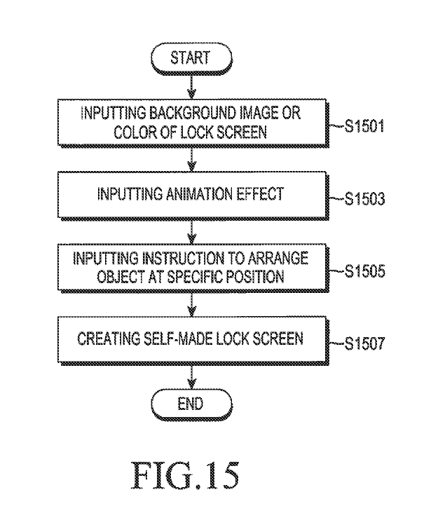

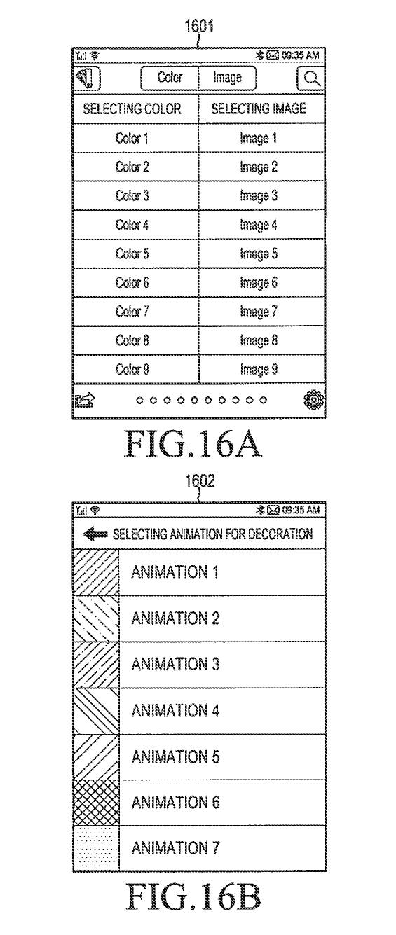

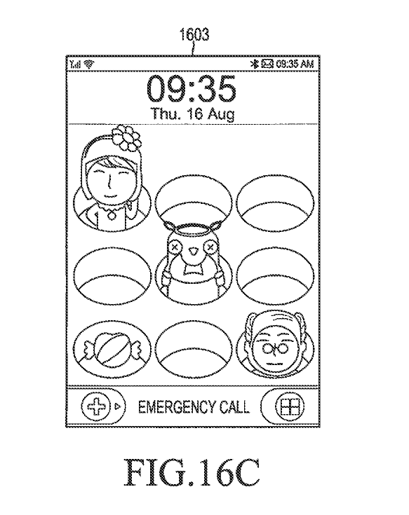

FIG. 15 is a flowchart illustrating a process of making a lock screen application according to another embodiment of the present invention, and FIGS. 16A to 16C are screen views of the authoring tool according to an embodiment of the present invention.

The electronic device 100 receives an input of a background image or color for the lock screen in step S1501. For example, in the embodiment of the authoring tool of FIG. 16A, the electronic device 100 may display various images or colors shown on screen 1601, and receive an input of at least one of various images or colors as a background screen value from the user.

Further, the electronic device 100 receives an input of an animation effect of a lock screen section in step S1503. For example, in the embodiment of the authoring tool of FIG. 16B, the electronic device 100 may display a list shown on screen 1602 of various animation effects, and receive an input of at least one of the animation effects as an animation effect of the lock screen section.

The electronic device 100 receives an input of an instruction to arrange at least one object at a specific position on the lock screen in step S1505. For example, the electronic device 100 may arrange at least one object at the specific position as shown on screen 1603 in FIG. 16C.

The electronic device 100 creates a lock screen application made therein based on at least one of the input background image or color, the animation effect and the object position in step S1507.

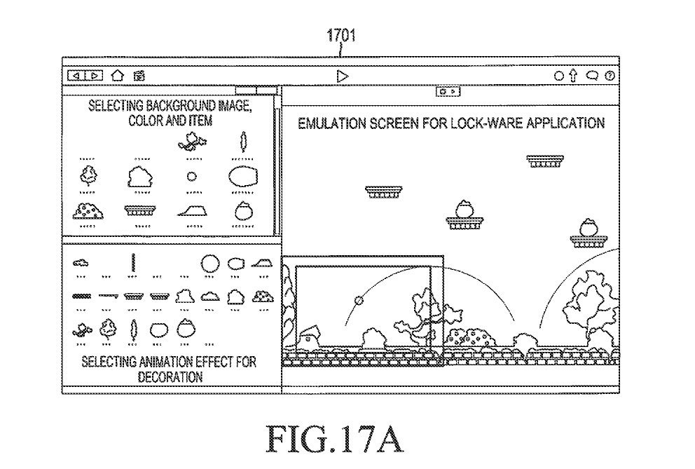

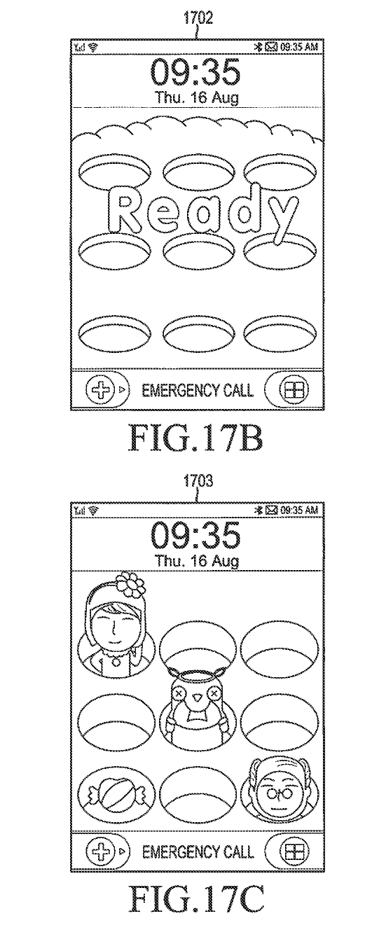

FIG. 17A is a conceptual screen view illustrating a PC based executable authoring tool 1701, and FIGS. 17B and 17C are conceptual screen views illustrating authoring tools 1702 and 1703 executed in a mobile device. The PC based executable authoring tool 1701 selects the lock screen background image or color according to the flowchart illustrating the process of making the lock screen application of FIG. 15. For example, in the embodiment of the authoring tool of FIG. 17A, the PC based executable authoring tool 1701 may select items constituting various background images, colors, or screens, and receive an input of at least one item selected from various background images, colors, or items as a value of the background screen.

In addition, in the embodiment of the authoring tool of FIG. 17A, it is possible to select an animation effect to decorate the lock screen section. For example, in the embodiment of the authoring tool of FIG. 17A, the PC based executable authoring tool may select a list or item of various animation effects for the decoration, select at least one of the effects, and receive an input of various effect event values of the lock screen section as an execution value.

Furthermore, in the embodiment of the authoring tool of FIG. 17A, in order to arrange the selected input information at the specific position on the lock screen, an object arrangement instruction for at least one object may be selected, and, for example, at least one object is arranged at the specific position.

The lock screen application made in the electronic device may be created based on at least one of the background image or color, the items, the animation effects for the decoration, and the object position, which are input through the authoring tool of FIG. 17A. The application made by the user can be identified through a preview function such that the application is previously executed through an emulation screen before a manufacturing of the application is actually completed as shown in the embodiment of the FIG. 17A. FIGS. 17B and 17C show an embodiment of the lock ware application actually made according to the flowchart illustrating the manufacturing process of FIG. 15 in the mobile device. FIG. 17B is a starting screen of the lock screen 1702, and FIG. 17C shows a screen 1703 of an embodiment in which an effect of the application made by the user using the authoring tool is executed.

It may be appreciated that the embodiments of the present invention can be implemented in software, hardware, or a combination thereof. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. Also, it will be appreciated that the embodiments of the present invention may be implemented by a computer or a portable terminal which includes a control unit and a memory, in which the memory may be an example of a storage medium that is readable by a machine that is suitable for storing one or more programs that include instructions for implementing the embodiments of the present invention. Accordingly, the present invention includes a program for a code implementing the apparatus and method described in the appended claims of the specification and a machine (a computer or the like)-readable storage medium for storing the program. Moreover, such a program as described above can be electronically transferred through an arbitrary medium such as a communication signal transferred through cable or wireless connection, and the present invention properly includes the things equivalent to that.

Further, the device can receive the program from a program providing apparatus connected to the device wirelessly or through a wire and store the received program. The program supply apparatus may include a program that includes instructions to execute the embodiments of the present invention, a memory that stores information or the like required for the embodiments of the present invention, a communication unit that conducts wired or wireless communication with the electronic apparatus, and a control unit that transmits a corresponding program to a transmission/reception apparatus in response to the request from the electronic apparatus or automatically.

While the present invention has been shown and described with reference to certain embodiments thereof, it will be understood by those skilled in the art that various changes in form and detail may be made therein without departing from the spirit and scope of the invention as defined by the appended claims.

What is claimed is:

1. A method of controlling an electronic device providing a lock screen, the method comprising:
providing the lock screen;
detecting and analyzing an event for outputting at least one output event which is input into the lock screen, and determining an output event to be output based on the analysis result;
determining at least one module for providing the output event corresponding to the analysis result, so as to provide an output instruction to output the output event to at least one determined module; and
outputting the output event by the at least one determined module.

2. The method as claimed in claim 1, wherein in detecting the event, location information of the electronic device is collected.

3. The method as claimed in claim 2, further comprising:
analyzing the collected location information of the electronic device so as to transmit an analysis result to outside of the electronic device; and
receiving content corresponding to the analysis result.

4. The method as claimed in claim 3, wherein in outputting the output event, the received content is displayed.

5. The method as claimed in claim 4, wherein the received content is at least one of an image and a photograph which correspond to a location of the electronic device, and a screen of a web browser which accesses a URL corresponding to a region in which the electronic device is located.

6. The method as claimed in claim 1, wherein in providing the lock screen, a multimedia embedded lock screen is displayed, and in detecting the event, a release pattern is received in the multimedia embedded lock screen in order to release the lock screen.

7. The method as claimed in claim 6, wherein in analyzing the detected event so as to determine the output event to be output, a first output event is determined as the output event when the release pattern is a preset pattern, and a second output event is determined as the output event when the release pattern is not the preset pattern.

8. The method as claimed in claim 7, wherein in outputting the output event, a screen of a web browser which accesses a URL corresponding to the lock screen is displayed when the release pattern is the preset pattern.

9. The method as claimed in claim 6, further comprising:
outputting a voice or a sound corresponding to the release pattern.

10. The method as claimed in claim 1, further comprising:
analyzing the detected event;
transmitting the analysis result to outside of the electronic device; and
receiving content corresponding to the analysis result,
wherein in providing the output instruction, the output instruction including the received content is provided to the module.

11. An electronic device for providing a lock screen, the electronic device comprising:
a lock-ware manager which provides the lock screen, and detects an event for outputting at least one output event input in the lock screen;
a lock-ware engine which analyzes the detected event, determines an output event to be output, determines at least one module which provides the output event, and transmits an output instruction to output the output event to at least one determined module; and
the at least one determined module which outputs the output event.

12. The electronic device as claimed in claim 11, wherein the lock-ware manager collects location information of the electronic device.

13. The electronic device as claimed in claim 12, wherein the lock-ware engine analyzes the collected location information of the electronic device, transmits an analysis result, and receives content corresponding to the analysis result.

14. The electronic device as claimed in claim 13, wherein the at least one module displays the received content.

15. The electronic device as claimed in claim 14, wherein the received content is at least one of an image and a photograph which correspond to a location of the electronic device, and a screen of a web browser which accesses a URL corresponding to a region in which the electronic device is located.

16. The electronic device as claimed in claim 11, wherein the lock-ware manager displays a multimedia embedded lock screen, and receives a release pattern for releasing the lock screen in the multimedia embedded lock screen.

17. The electronic device as claimed in claim 16, wherein the lock-ware engine determines a first output event as the output event when the release pattern is a preset pattern, and determines a second output event as the output event when the release pattern is not the preset pattern.

18. The electronic device as claimed in claim 17, wherein the lock-ware engine displays a screen of a web browser which accesses a URL corresponding to the lock screen when the release pattern is the preset pattern.

19. The electronic device as claimed in claim 16, wherein the lock-ware engine outputs a voice or a sound corresponding to the release pattern.

20. The electronic device as claimed in claim 11, wherein the lock-ware engine analyzes the detected event, transmits an analysis result to outside of the electronic device, receives content corresponding to the analysis result, and transmits an output instruction including the received content to the module.
